(19) United States
(12) Patent Application Publication
(10) Pub. No.: US 2026/0012836 A1
(43) Pub. Date: Jan. 8, 2026

(54) FACILITATING MULTIPLE-TENANT ENERGY EFFICIENT RADIO ACCESS NETWORK SHARING IN ADVANCED COMMUNICATION NETWORKS

(71) Applicant: Dell Products, L.P., Round Rock, TX (US)

(72) Inventors: Jeebak Mitra, Ottawa (CA); Gwenael Poitau, Montreal (CA)

(21) Appl. No.: 18/763,648

(22) Filed: Jul. 3, 2024

(51) Int. Cl. H04W 28/02; H04L 41/16; H04W 24/02; H04W 52/02; H04W 72/1263

(52) U.S. Cl. CPC H04W 28/0221; H04L 41/16; H04W 24/02; H04W 28/0247; H04W 52/0203; H04W 72/1263

(57) ABSTRACT

Facilitating Multiple-Tenant Energy Efficient Radio Access Network Sharing In Advanced Communication Networks is provided. A method includes facilitating, by a system comprising at least one processor, network energy savings in a communications network that is deployed in a shared radio access network architecture. The facilitating includes implementing, at a network operator level of the communications network according to a defined energy efficiency criterion, energy efficient scheduling of user equipment within the communications network. The facilitating also includes implementing, at an infrastructure provider level of the communications network, network energy savings actions based on respective measured quality of service levels of the user equipment being retained at or above a defined quality of service level. In an example, network equipment comprised by the communications network is configured to operate according to at least a fifth generation radio network communication protocol.

### BACKGROUND

The use of computing devices is ubiquitous. Given the explosive demand placed upon current mobile networks and the advent of advanced use cases (e.g., streaming, gaming, and so on), power consumption in such networks is higher as compared to previous generations such as Long Term Evolution (LTE) networks, for example. Such power consumption can be attributed to the exponential increase in the network data flowing through the network and the need for faster processing of complex tasks to enable the high data rates. Accordingly, unique challenges exist related to network efficiency and in view of Fifth Generation (5G)-new radio (NR), Sixth Generation (6G), or other next generation, standards for network communication.

The above-described context with respect to communication networks is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes facilitating, by a system comprising at least one processor, network energy savings in a communications network that is deployed in a shared radio access network architecture. The shared radio access network architecture comprises radio access network hardware controllable by provider equipment associated with an infrastructure provider. A group of network operators share the radio access network hardware. Respective operator equipment associated with the group of network operators facilitate wireless communications coverage to a communication region defined by the communications network. The facilitating includes implementing, at a network operator level of the communications network according to a defined energy efficiency criterion, energy efficient scheduling of user equipment within the communications network. The facilitating also includes implementing, at an infrastructure provider level of the communications network, network energy savings actions based on respective measured quality of service levels of the user equipment being retained at or above a defined quality of service level. In an example, network equipment comprised by the communications network is configured to operate according to at least a fifth generation radio network communication protocol.

Respective network operators of the group of network operators are associated with respective network policies. In some implementations, implementing the energy efficient scheduling includes implementing respective energy efficient scheduling associated with the respective network operators based on the respective network policies. Further, the method can include optimizing, by the system, the respective network policies. The optimizing comprises using intra-network operator deep reinforcement learning loops.

According to some implementations, the method can include employing, by the system, a data-driven deep reinforcement learning based optimization. An objective of the data-driven deep reinforcement learning based optimization can be a reduction of a value of a global energy metric. Further to these implementations, employing of the data-driven deep reinforcement learning based optimization is performed at the infrastructure provider level of the communications network.

Respective network operators of the group of network operators are associated with respective network policies. The method can include optimizing, by the system, the respective network policies. The optimizing can include using intra-network operator deep reinforcement learning loops. The method can also include employing, by the system, a data-driven deep reinforcement learning based optimization. An objective of the data-driven deep reinforcement learning based optimization is a reduction of a value of a global energy metric. In addition, the optimizing and the employing are performed based on a defined hierarchy applicable to data used as input to respective deep reinforcement learning processes.

Further to the above implementations, the method can include executing, by the system, the data-driven deep reinforcement learning based optimization at a first timescale. The method can also include executing, by the system, the intra-network operator deep reinforcement learning loops at a second timescale. The first timescale and the second timescale are different time scales. In an example, the first timescale comprises a first length that is at least three times longer than a second length of the second timescale.

Additionally, or alternatively, the method can include, for using of the intra-network operator deep reinforcement learning loops, training, by the system, respective deep reinforcement learning loops. The training can be based on achieving convergence for a first deep reinforcement learning loop running at a lowest time scale, as compared to time scales for other deep reinforcement learning loops, other than the first deep reinforcement learning loop, prior to achieving convergence from the other deep reinforcement learning loops.

Another embodiment relates to a system that includes at least one processor and at least one memory that stores executable instructions that, when executed by the at least one processor, facilitate performance of operations. The operations can include implementing, at an operator level of a cellular network deployed as a shared radio access network architecture, energy efficient scheduling of user equipment within the cellular network in accordance with a defined energy efficiency metric. The operations can also include implementing, at an infrastructure provider level of the cellular network, network energy savings actions in accordance with a defined energy savings metric based on respective measured quality of service levels of the user equipment being retained at or above a defined quality of service level.

In an embodiment, the shared radio access network architecture comprises radio access network hardware controlled by an infrastructure provider at the infrastructure provider level. A group of network operators share the radio access network hardware at the operator level of the cellular network. Further, the group of network operators facilitate wireless communications coverage to a communication region defined by the cellular network.

According to some embodiments, respective network operators of the group of network operators are associated with respective network policies. In these embodiments, implementing of the energy efficient scheduling can include implementing respective energy efficient scheduling associated with the respective network operators based on the respective network policies. Further, the operations can include modifying the respective network policies using intra-network operator deep reinforcement learning loops based on additional training information having become available as input for the intra-network operator deep reinforcement learning loops.

In some embodiments, the operations can include employing a data-driven deep reinforcement learning based optimization. An objective of the data-driven deep reinforcement learning based optimization is a modification of a value of a global energy metric to achieve a reduction in global energy usage.

The operations can include, according to some implementations, optimizing the respective network policies. The optimizing can include using intra-network operator deep reinforcement learning loops. The operations can also include employing a data-driven deep reinforcement learning based optimization. An objective of the data-driven deep reinforcement learning based optimization is a reduction of a value of a global energy metric to achieve a reduction in global energy usage.

Further to the above implementations, the operations can include executing the data-driven deep reinforcement learning based optimization at a first time interval. In addition, the operations can include executing the intra-network operator deep reinforcement learning loops at a second time interval. The first time interval and the second time interval are different time intervals. For example, the first time interval comprises a first length that is longer than a second length of the second time interval.

Yet another embodiment relates to a non-transitory machine-readable medium, comprising executable instructions that, when executed by at least one processor of network equipment, facilitate performance of operations. The operations can include configuring operations of network equipment of a communications network for energy efficiency according to a defined energy efficiency criterion. The communications network is deployed in a shared radio access network architecture. The configuring can include implementing, at a network operator level of the communications network applicable to network operator equipment of the communications network, energy efficient scheduling of user equipment within the communications network according to the defined energy efficiency criterion. The configuring can also include implementing, at an infrastructure provider level of the communications network applicable to infrastructure provider equipment of the communications network, network energy savings actions based on respective measured quality of service levels of the user equipment being retained at or above a defined quality of service level.

Respective network operator equipment of respective network operators of a group of network operators at the network operator level are associated with respective network policies. Further, the operations can include modifying respective network policies using intra-network operator deep reinforcement learning loops and reducing a value of a global energy metric comprising employing data-driven deep reinforcement learning loops. The modifying and the employing are performed independent from one another.

In some embodiments, the operations can include training at least one of first loops of the intra-network operator deep reinforcement learning loops or second loops of the data-driven deep reinforcement learning loops based on having achieved a first convergence for a first deep reinforcement learning loop running at a lowest time scale, as compared to time scales for second deep reinforcement learning loops, other than the first deep reinforcement learning loop, prior to having achieved second convergence from the second deep reinforcement learning loops.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, schematic representation of a system for radio access network sharing with infrastructure providers hosting mobile network operator as tenants in accordance with one or more embodiments;

FIG. 2 illustrates an example, non-limiting, system for multi-tenant radio access network sharing in accordance with one or more embodiments;

FIG. 3 illustrates an example, non-limiting, system that utilizes network energy sharing-hierarchical deep reinforcement learning loops for multiple-tenant energy efficient radio access network sharing in advanced communication networks in accordance with one or more embodiments;

FIG. 4 illustrates an example, non-limiting, system that utilizes a hierarchical reinforcement learning framework for energy efficiency in shared radio access network in accordance with one or more embodiments;

FIG. 5 illustrates an example, non-limiting, flow diagram of an example, non-limiting, computer-implemented method that facilitates training of multilevel hierarchical deep reinforcement learning for network energy savings for a shared-radio access network in accordance with one or more embodiments described herein;

FIG. 6 illustrates an example, non-limiting, flow diagram of an example, non-limiting, computer-implemented method that facilitates a training schedule for deep-reinforcement learning based network energy savings in a shared-radio access network in accordance with one or more embodiments described herein;

FIG. 7 illustrates an example, non-limiting, flow diagram of an example, non-limiting, computer-implemented method that facilitates multiple-tenant energy efficient radio access network sharing in advanced communication networks in accordance with one or more embodiments described herein;

FIG. 8 illustrates an example, non-limiting, flow diagram of an example, non-limiting, computer-implemented method that utilizes optimization loops to facilitate multiple-tenant energy efficient radio access network sharing in accordance with one or more embodiments described herein;

FIG. 9 illustrates an example, non-limiting, computing environment in which one or more embodiments described herein can be facilitated;

FIG. 10 illustrates an example, non-limiting, networking environment in which one or more embodiments described herein can be facilitated;

FIG. 11 illustrates a first equation that represents a total number of user served in accordance with one or more embodiments;

FIG. 12 illustrates a second equation that represents an aggregate traffic demand in accordance with one or more embodiments;

FIG. 13 illustrates a third equation that represents the total power consumption of infrastructure provider hosted shared-radio access network in accordance with one or more embodiments;

FIG. 14 illustrates a term of the third equation that denotes the elements of the user association matrix in accordance with one or more embodiments;

FIG. 15 illustrates a fourth equation in accordance with one or more embodiments;

FIG. 16 illustrates a fifth equation resulting from a split of the traffic dependent part of the fourth equation in accordance with one or more embodiments;

FIG. 17 illustrates a sixth equation in accordance with one or more embodiments;

FIG. 18 illustrates a seventh equation that represents the aggregate data rate achieved through the shared radio access networks in accordance with one or more embodiments;

FIG. 19 illustrates an eighth equation that represents the energy efficiency as a ratio of the data rate over power consumed to carry the data in accordance with one or more embodiments;

FIG. 20 illustrates a ninth equation that represents an optimization objective in accordance with one or more embodiments;

FIG. 21 illustrates a tenth equation of a first constraint that represents the quality of service of individual users in accordance with one or more embodiments;

FIG. 22 illustrates an eleventh equation of a second constraint that represents the total energy consumed by all the shared radio access networks in accordance with one or more embodiments;

FIG. 23 illustrates a twelfth equation that represents a joint user association check in accordance with one or more embodiments; and

FIG. 24 illustrates a thirteenth equation that represents a reward function in accordance with one or more embodiments.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

Fifth generation (5G) networks are expected to provide improved throughput through increased network densification. For example, network densification can include more base stations per square area while supporting a complex set of features which tend to be power hungry compared to previous generations (e.g., Third Generation 3G networks, Fourth Generation 4G networks, and so on).

Consequently, network deployment costs are becoming increasingly high and with stagnating Average Revenue Per User (ARPU) operators are motivated to adopt models that lead to cost-efficient network rollouts while maintaining network performance indicators (e.g., key performance indicators (KPIs)) to enable high user retention.

Therefore, there is definite need for solutions that are cost effective and at the same time provide the purported benefits of 5G in terms of increased throughputs, reduced latency and the like while keeping energy costs low.

Network sharing has evolved from a novel concept a few years back to a prominent feature of emerging 5G networks along with the use of small cells to provide high throughput which however have increased overheads due to interference, handovers etc. Moreover, when designing networks for high throughput, very little attention has been paid to the corresponding increase in energy consumption and therefore high energy efficiency has now become a focal point for network design. Network sharing, conceptually, has been there in previous generations of cellular standards (e.g., Multi Operator-Radio Access Network (MORAN), it has been inefficient or non-existent due to lack of significant virtualization of network functions along with lack of operator support. It is noted that Multi-Operator Core Network (MOCN) is not considered in the above evaluation as CN is a negligible contributor to network energy consumption.

The embodiments provided herein are a novel approach to Radio Access Network (RAN) sharing when the network operators are tenants of an infrastructure provider (InP) such as to reduce overall energy footprint of the network. In particular, provided herein are embodiments related to reducing and/or mitigating energy consumption in a data-driven fashion in a shared-RAN architecture whereby the energy consuming elements of the RAN hardware are owned and operated by an infrastructure provider that hosts multiple network operators as logical RANs. The RANs are able to implement their own network energy savings (NES) policy individually by applying energy efficient scheduling at their end and implementing ES features, such as advanced sleep mode (ASM) and carrier/cell switch on-off (CSO). The InP also works in a data-driven fashion, in tandem with the MNOs to control actions that improve NES while ensuring a user association that allows the user QoS to be satisfied.

Advanced communications networks (e.g., 5G and beyond 5G (B5G) networks) will usher in several advanced features for the user including ultra-high speeds, low-latency, and connectivity for hundreds of devices. Implementation of such advanced features also comes at significant cost and network operators are incurring huge amounts of debt to roll-out 5G in all markets in which they operate.

While capital expenditure (CAPEX) captures the initial roll out cost of the networks, operating expense (OPEX) aspects are becoming significant as well especially with high energy consumption cost of operating these networks. In fact, energy consumption by RAN is often responsible for a large amount of the OPEX costs.

RAN sharing has been shown to have the potential to save between 20-30% of the network deployment cost through a combination of spectrum and physical infrastructure sharing. In a shared RAN (S-RAN), a user can be served either through the network of his home operator or the network of another service operator in the shared system.

Nonetheless, several important aspects need to be addressed prior to making a selection decision such that all the involved parties (e.g., the user, the home operator, the service operator), are satisfied. In particular, the extent of sharing may determine the ability of an operator to differentiate its services from that of the competition. For example, if the requirement to share network physical resources limits an operator's service differentiation ability, it will likely be deterrent to adoption. The operational aspects of this may be further complicated by the ownership structure as there may be infrastructure providers (InP) that own complete RAN physical elements and then provide that equipment as a service to various operators giving rise to the notion of RAN as a Service (RANaaS) just as Network as a Service (NaaS) has become a popular for IP network connectivity.

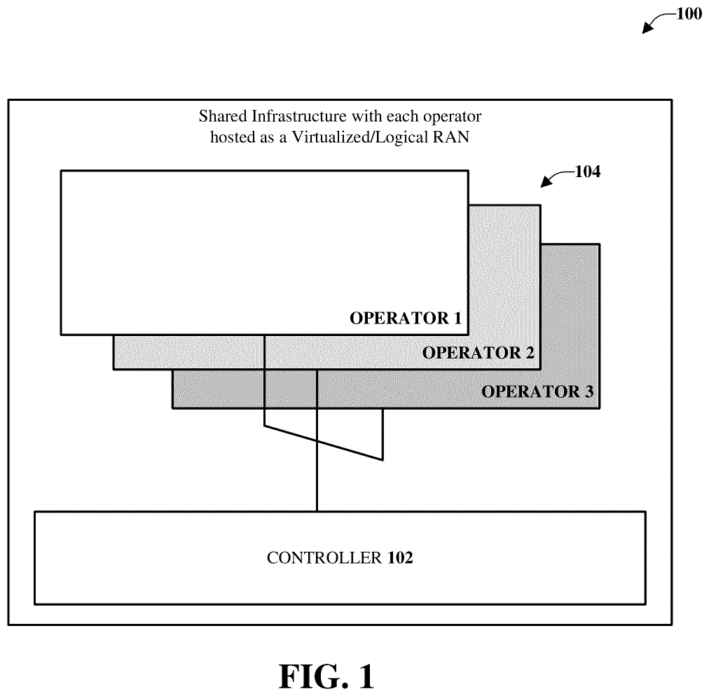

FIG. 1 illustrates an example, non-limiting, schematic representation of a system 100 for RAN sharing with InP hosting MNO as tenants in accordance with one or more embodiments. Provided herein is a RAN sharing model where a given coverage area is split between two or more operators whereby each operator manages the RAN in a specific area, while sharing its RAN infrastructure and potentially computing resources with its partner operators. The disclosed embodiments apply to the scenario where there are essentially two sets of entities, namely, Infrastructure Providers (InPs) and Mobile Network Operators (MNOs). The InPs own the actual physical network and are responsible for its maintenance and operational aspects. Typically the InPs provide leased services to MNOs. The MNOs own radio spectrum but use the RAN equipment hosted by InPs to provide coverage and capacity to users in their network.

As illustrated in FIG. 1, the system 100 includes a controller 102 and multiple operators, illustrated collectively at 104. The controller 102 can be, for example, an InP energy saving controller for shared infrastructures. Although only three operators are illustrated at 104 (e.g., operator 1, operator 2, and operator 3), another number of operators can be included in the system 100.

The InP (e.g., the controller 102) treats or manages the MNOs as logical entities that either place a request to dynamically use its resources (e.g., the resources of the InP) or as in legacy models that have pre-arranged leased resources.

In both configurations (e.g., the dynamic use of resources, the pre-arranged leased resources), minimizing and/or reducing energy consumption of operational networks is a shared responsibility with the constraints of maintaining user Quality of Service (QoS).

Various energy savings actions are used by the InP (e.g., the controller 102). Optimizing energy efficiency through RAN sharing can be categorized based on the resource type to be optimized. The resource type can include physical elements such as antenna and/or Radio Resource Head (RRH) resource elements, Base Band Unit (BBU) resource elements or hybrid resource elements focusing jointly on RRH and BBU elements. Alternatively or additionally, the resource type can include logical aspects such as user association or handover management, with resource allocation, operational mode, and so on, being managed individually by MNOs to optimize such usage per their own policy.

In this regard for the avoidance of doubt, any embodiments described herein in the context of optimizing energy efficiency and/or other aspects are not so limited and should be considered also to cover any techniques that implement underlying aspects or parts of the described aspects to improve or increase energy efficiency and/or other aspects, even if resulting in a sub-optimal variant obtained by relaxing aspects or parts of a given implementation or embodiment.

Conventional processes related to network energy savings in shared RAN suffer from various deficiencies. For example, there can be less focus on energy efficiency in shared RAN Architectures. Conventional processes in this area typically address the macro question of base station (BS) on and/or off (ON/OFF) whereby saving energy primarily occurs by completely turning off the BS and thus potentially creating coverage holes or service degradation. Further, energy efficiency, although an important aspect, was not considered a critical design factor since, for example, network densification was much lower than the scenarios envisioned for 5G and beyond.

Further, the level of complexity in RAN sharing is higher than previous generations. The first instances of self-optimization (SON) applied to networks was adapted based on single-metric control loops and fixed threshold-based comparisons. However, managing more complex scenarios, with multi-factor dependencies is beyond the scope of the current conventional approaches and prudent application of data-driven approaches such as Machine Learning and/or Deep Learning (ML/DL) is needed to properly mine the data gathered by the Self-Organizing Network (SON) modules.

Additionally, there has been a lack of data-driven approaches in network resource optimization with multiple participating entities. Network data collection and data processing becomes a significantly complicated task when there are multiple parties (InP and operators) involved and additional burdens are therefore placed on designing architectures that can potentially lead to adoption of globally optimally policies. Additionally, although supervised ML methods have shown promising results in several wireless network operational optimization problems, they require the availability of a large amount of a priori labeled training and testing data which is difficult to obtain for all relevant practical scenarios.

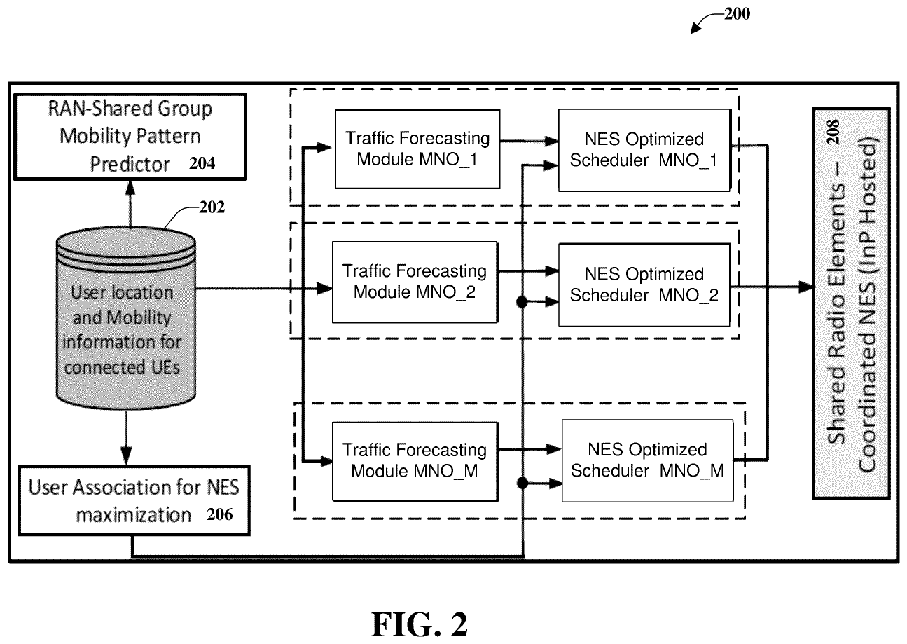

FIG. 2 illustrates an example, non-limiting, system 200 for multi-tenant RAN sharing in accordance with one or more embodiments. Specifically, the system 200 depicts functional aspects of NES in multi-tenant RAN sharing.

There are various attributes that affect how RAN sharing occurs in 5G and beyond. For example, an attribute is the amount of virtualization in network functions that allow a pooling of resources and centralization of functions such that the implementation and hardware cost can be amortized in a straightforward fashion due to changes in logical entities only. Another attribute is the inherent availability of data and the requisite compute capability to apply data-driven policy making adopting techniques from ML and having continuous data pipelines to enable online learning as well. Yet another attribute is a combination of the above giving rise to the notion of adaptively shared RAN and the pressing need to do so due to higher densification (and hence deployment cost) of the network.

According to the disclosed embodiments, network operators have full visibility and control of the Distributed Unit (DU) and high-PHY processing, however, the radio operations and lower-PHY core operations that involve power consuming Fast Fourier Transform/Inverse Fast Fourier Transform (FFT/iFFT) and Forward Error Correction (FEC) related operations may have a common shared pool of processors. Moreover, the radio front end and antennas are fully shared either in an RRH configuration, cloud-RAN (C-RAN), virtual-RAN (v-RAN) based architecture or by other means as with be discussed in further detail below.

RAN-specific energy-saving features can be made autonomous for actual network operation if they are solely event-driven or activated on demand by AI/ML driven NES policies. Such examples include cell/carrier switch ON/OFF and radio frequency (RF) channel sleep.

When InP are engaged in NaaS RAN-sharing, MNOs can have control of the activation and deactivation of energy-saving features involving various radio resources. Individual operator differentiation will need to be designed such that energy saving features (ESFs) are independently upgradeable. To reduce the data shared with InPs, RAN energy-saving features can be implemented as a part of a logical RAN which is not part of the shared infrastructure layer.

With continuing reference to FIG. 2, the system 200 can facilitate NES enhancement using RAN sharing. The system 200 includes a data store 202 that determines and/or retains information related to user location and mobility information for connected UEs. Also included is a RAN-Shared group mobility pattern predictor 204 and a user association for NES maximization determiner 206. There are one or more traffic forecasting modules for the different network operators, illustrated as a first traffic forecasting module for a first operator (MNO₁), a second traffic forecasting module for a second operator (MNO₂), through an M^{th} traffic forecasting module for an M^{th} operator (MNO_{M}), where M is an integer greater than or equal to zero. Also included in the system, are one or more NES optimized schedulers, illustrated as a first NES optimized scheduler for the first operator (MNO₁), a second NES optimized scheduler for the second operator (MNO₂), through an M^{th} NES optimized scheduler for the M^{th} operator (MNO_{M}), where M is an integer greater than or equal to zero. In addition, the system 200 includes shared radio elements 208 for coordinated NES (InP Hosted).

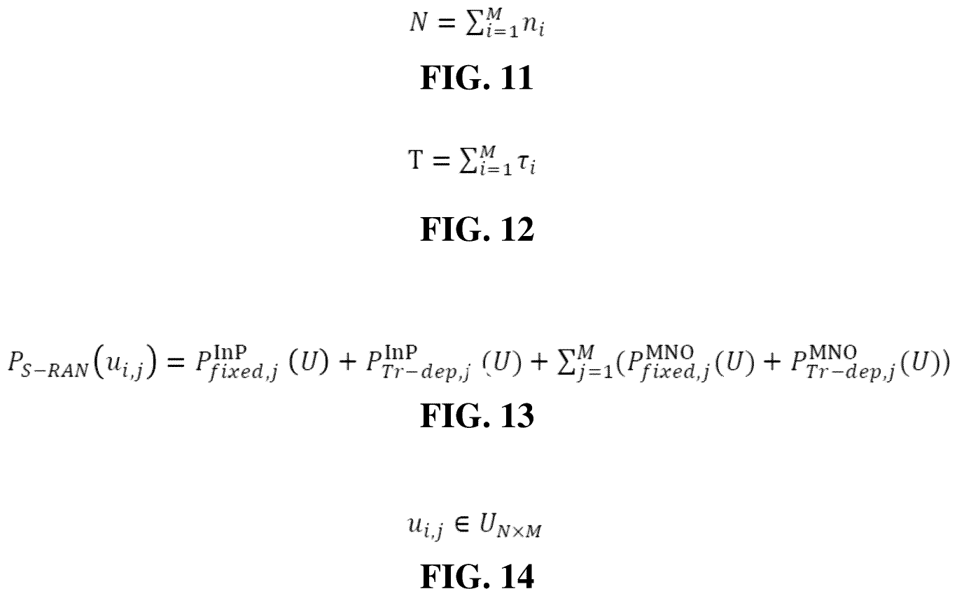

Each tenant MNO in the shared-RAN coverage space serves a fraction (ηᵢ) of users such that a total of N users are served for an aggregate traffic demand T and the following first equation (Eqn.(1)) and second equation (Eqn.(2)), also illustrated in FIG. 11 and FIG. 12 respectively, in accordance with one or more embodiments, hold:

$$N = {\sum }_{i = 1}^{M} {n}_{i} \qquad Eqn ( 1 )$$

$$T = {\sum }_{i = 1}^{M} {τ}_{i} \qquad Eqn ( 2 )$$

where τᵢ is the traffic demand on each individual RAN.

The functional aspects of the RAN sharing are depicted at a high level in FIG. 2 where the decision making is aided by two modules (a) Mobility pattern detector for the shared-RAN and (b) traffic demand predictors for each of the MNOs (\hat{τ}ᵢ). The system 200 is configured to determine the optimal user association (UA) such that energy consumption of the shared-RAN can be minimized.

When the UEs are connected, the MNOs themselves further enable energy saving features (ESF) through the various “NES optimized schedulers” that facilitate various roles. For example, the NES optimized schedulers can employ L2 (MAC) and L3 (Radio Resource Management (RRM)) policies that optimize the energy consumption of the network (e.g., creating more symbol blanking opportunities). In another example, the NES optimized schedulers can employ NES policies for scheduling that recommend low power operational states to the shared-RAN RF elements of the InP. It is noted that ES policies and/or states recommended by individual MNOs may not be applied by the InP until all of them are able to service their users per the capabilities of the reduced power operational state.

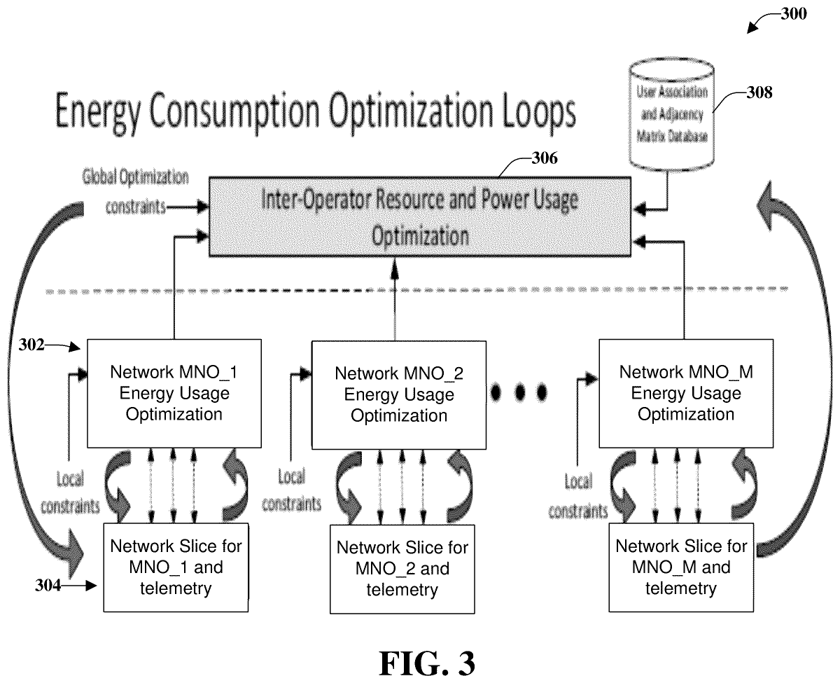

FIG. 3 illustrates an example, non-limiting, system 300 that utilizes NES-Hierarchical DRL loops for multiple-tenant energy efficient radio access network sharing in advanced communication networks in accordance with one or more embodiments.

To reduce and/or mitigate the data shared with InPs, RAN energy-saving features can be implemented as a part of a logical RAN which is not part of the shared infrastructure layer. Each MNO can obtain telemetry information and use that telemetry information to configure the network slices that it sends over the shared-RAN infrastructure.

As it relates to a Distributed Energy Savings architecture, the InP controls the activation-deactivation of some of the physically shared infrastructure resources, the energy savings with respect to a common resource will only be achievable when all the sharing MNOs can meet their network key performance indicators (KPIs) and deactivate it. Overall, the InP and network operator should have in the sharing architecture in-built coordination requirements for the energy management of shared hardware units. Such coordination can be achieved by separating the InP energy management of the multiple logical RANs and the MNO ESFs within each logical RAN.

FIG. 3 details how the optimizations loops operate. Each network operator is associated with a network energy usage optimization module, indicated generally at 302. For example, as depicted, a first network operator (MNO₁) is associated with network MNO₁ energy usage optimization module, a second network operator (MNO₂) is associated with network MNO₂ energy usage optimization module, through an M^{th} network operator (MNO_{M}), which is associated with network MNO_{M} energy usage optimization module.

The respective network energy usage optimization modules select the appropriate network slice for the particular operator, indicated generally at 304. For example, the network MNO₁ energy usage optimization module selects network slice for MNO₁ and associated telemetry data. The network MNO₂ energy usage optimization module selects network slice for MNO₂ and associated telemetry data. Further, the network MNO_{M} energy usage optimization module selects network slice for MNO_{M} and associated telemetry data.

The associated telemetry data is utilized to determine where energy is actually being minimized, or is not being minimized. Such telemetry data can be analyzed to measure whether the particular energy savings policy enacted is effective. The telemetry is restricted to a given operator such that the measurements will only be performed (e.g., the relevant network information will be obtained) when that particular operator is active. Such information is fed into the optimization loops, indicated by the arrows, between the network energy usage optimization module and its associated network slice and telemetry. These optimization loop represent intra-operator loops, which are implemented by the network operators and represent local constraints that are only applicable to the network operators.

An inter-operator resource and power usage optimization module 306 is implemented by the infrastructure operator. This module places global constraints in the global optimization loop, indicated by the arrows between inter-operator resource and power usage optimization module 306 and the network slice and telemetry 304.

The information obtained via the local loops and the global loops can be retained in a data structure 308. Such information can include details related to which UE is associated with which network and can be utilized to determine whether a UE should be transferred between networks without affecting the service level.

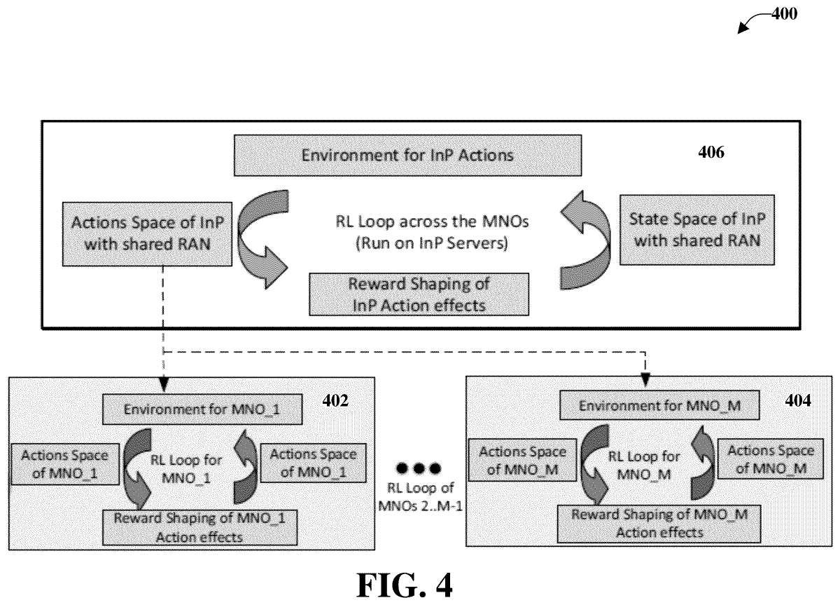

FIG. 4 illustrates an example, non-limiting, system 400 that utilizes a hierarchical RL framework for energy efficiency in shared RAN in accordance with one or more embodiments. More specifically, illustrated are multi-level DRL loops to address the NES actions space that span different time scales.

Depicted in FIG. 4 is a learning framework that includes two levels at which EE improvement loops will operate. The levels include an intra-MNO loop and an inter-MNO loop. The intra-MNO loop is where the actions are taken such that the scope of the impact is only on the QoS of the users served by that MNO and the user association is considered an input. The inter-MNO loop is where the resource allocation decision between different MNOs is made such that a global metric with respect to energy efficiency (EE) is optimized.

The following will describe the interaction between the loops. While there is no direct interaction between the RL loops of the different MNOs, and the specific actions taken by each MNO can be quite different, it does affect the overall global environment and may thus influence the RL environment for the InP. Conversely, the actions taken by the InP are global in the sense that they affect the RL environment for individual MNOs and essentially the rewards for their individual actions.

There are several benefits to exploring NES in S-RAN in such multi-level fashion with sequential execution. Different agents with different objectives and following different policies can coexist and co-operate with each other in the same environment to achieve a common goal. Large computational and memory requirements in a centralized architecture is avoided and edge-based compute can handle the intra-MNO loops as wells the inter MNO-loops of the InP due to the decoupling of the compute.

As depicted in FIG. 4 is an environment for a first mobile network operator (environment for MNO_1 402) through an environment for an M^{th} network operator (environment for MNO_M 404), where M is an integer greater than or equal to zero. Also depicted is an environment for InP actions 406.

The environment for MNO_1 402 and the environment for MNO_M 404 comprise similar elements. Such elements include actions space of the respective MNO, and reward shaping of the respective MNO action effects. Also depicted is the reinforcement learning loop, indicated by the arrows, for the respective MNOs, which are local to the MNO. The environment for InP actions 406 includes the action space of InP with shared RAN and the reward shaping of InP action effects. The RL Loop, indicated by the arrows, is across the MNOs and is executed on the InP servers. Further details related to the reward shaping will be provided below.

Typically, resource allocation by a single RAN is to meet certain throughput demand under a QoS constraint and that will continue to be the case here as well as the KPI constraints apply regardless of how the demand is met. Total power consumption of InP hosted Shared-RAN (S-RAN) is represented as indicated in the following third equation (Eqn.(3)), also illustrated in FIG. 13, in accordance with one or more embodiments:

$${P}_{S - RAN} ( {u}_{i , j} ) = {P}_{fixed}^{lnP} ( U ) + {P}_{Tr - dep}^{lnP} ( U ) + {\sum }_{j = 1}^{M} ( {P}_{fixed , j}^{MNO} ( U ) + {P}_{Tr - dep , j}^{MNO} ( U ) ) \qquad Eqn . ( 3 )$$

where, μ_{i,j} ∈_{N×M} (also illustrated in FIG. 14), denotes the elements of the user association matrix U for a total of ‘N’ users and ‘M’ is the number of networks and/or MNOs that are sharing the RAN. P_{fixed} is the fixed power consumption of the shared RAN that is attributed to both the InP and the MNOs when carrying no traffic with ‘K’ users in the aggregate service area. ‘K’ can represent the number of active users. According to some implementations, ‘K’ is equal to ‘N’ (e.g., all users are active users).

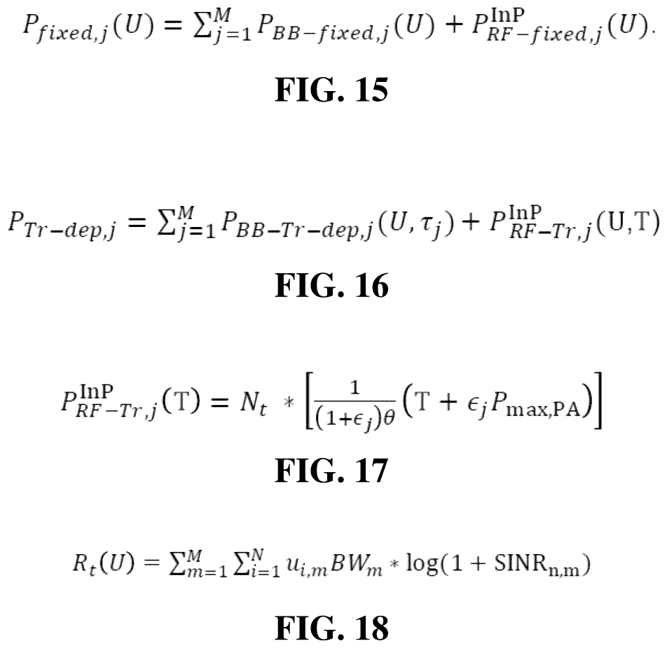

Eqn.(3) includes the impact of both baseband power consumption P_{BBj} which is primarily controlled by the MNOs and the fixed RF power expended in keeping the RF circuits powered up and ready for carrying traffic P_{RF-fixed,j} which in our multi-tenant model is provisioned by the InP, therefore a fourth equation (Eqn.(4)) applies as noted below and also illustrated in FIG. 15, in accordance with one or more embodiments:

$${P}_{fixed , j} ( U ) = {\sum }_{j = 1}^{M} {P}_{BB - fixed , j} ( U ) + {P}_{RF - fixed , j}^{lnP} ( U ) \qquad Eqn . ( 4 )$$

The traffic dependent part can be split into a fifth equation (Eqn.(5)) below and also illustrated in FIG. 16, in accordance with one or more embodiments:

$${P}_{Tr - dep , j} = {\sum }_{j = 1}^{M} {P}_{BB - Tr - dep , j} ( U , {τ}_{j} ) + {P}_{RF - Tr , j}^{lnP} ( U , T ) \qquad Eqn . ( 5 )$$

with a sixth equation (Eqn.(6)) below and also illustrated in FIG. 17, in accordance with one or more embodiments.

$${P}_{RF - Tr , j}^{lnP} ( T ) = {N}_{t} * [ \frac{1}{( 1 + {ϵ}_{j} ) θ} ( T + {ϵ}_{j} {P}_{max , PA} ) ] \qquad Eqn . ( 6 )$$

where Nₜ is the number of transmit antennas that are active, εⱼ and P_{max,PA} denote the Power Amplifier (PA) efficiency and maximum power of the PA, respectively.

Additionally, the aggregate data rate achieved through the ‘M’ shared RANs is expressed in a seventh equation (Eqn.(7)) below and also illustrated in FIG. 18, in accordance with one or more embodiments.

$${R}_{t} ( U ) = {\sum }_{m = 1}^{M} {\sum }_{i = 1}^{N} {u}_{i , m} {BW}_{m} * log ( 1 + {SINR}_{n , m} ) \qquad Eqn . ( 7 )$$

where SINR_{n,m} is the SINR for the n^{th} user when it is connected to the m^{th} RAN and BWₘ is its total usable bandwidth.

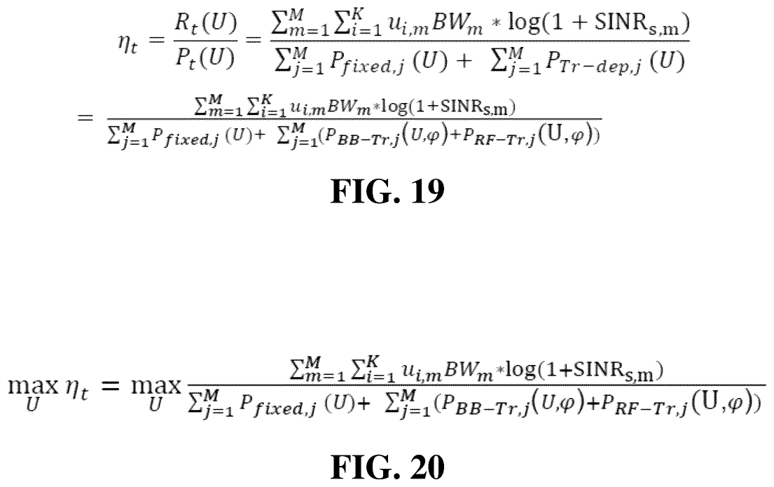

Expressing the energy efficiency as a ratio of the data rate over power consumed to carry the data as indicated in an eighth equation (Eqn.(8)), depicted below and also illustrated in FIG. 19, in accordance with one or more embodiments.

$${η}_{t} = \frac{{R}_{t} ( U )}{{P}_{t} ( U )} = \frac{{\sum }_{m = 1}^{M} {\sum }_{i = 1}^{K} {u}_{i , m} {BW}_{m} * log ( 1 + {SINR}_{s , m} )}{{\sum }_{j = 1}^{M} {P}_{fixed , j} ( U ) + {\sum }_{j = 1}^{M} {P}_{Tr - dep , j} ( U )} = \frac{{\sum }_{m = 1}^{M} {\sum }_{i = 1}^{K} {u}_{i , m} {BW}_{m} * log ( 1 + {SINR}_{s , m} )}{\begin{matrix}{\sum }_{j = 1}^{M} {P}_{fixed , j} ( U ) + \\ {\sum }_{j = 1}^{M} ( {P}_{BB - Tr , j} ( U , φ ) + {P}_{RF - Tr , j} ( U , φ ) )\end{matrix}} \qquad Eqn . ( 8 )$$

Therefore, the optimization objective is formulated as a ninth equation (Eqn.(9)) depicted below also illustrated in FIG. 20, in accordance with one or more embodiments.

$${max}_{U} {η}_{t} = {max}_{U} \frac{{\sum }_{m = 1}^{M} {\sum }_{i = 1}^{K} {u}_{i , m} {BW}_{m} * log ( 1 + {SINR}_{s , m} )}{\begin{matrix}{\sum }_{j = 1}^{M} {P}_{fixed , j} ( U ) + \\ {\sum }_{j = 1}^{M} ( {P}_{BB - Tr , j} ( U , φ ) + {P}_{RF - Tr , j} ( U , φ ) )\end{matrix}} \qquad Eqn . ( 9 )$$

It is noted that Eqn.(9) is a non-convex optimization problem and, thus, solving Eqn.(9) using legacy (convex) optimization approaches is not feasible.

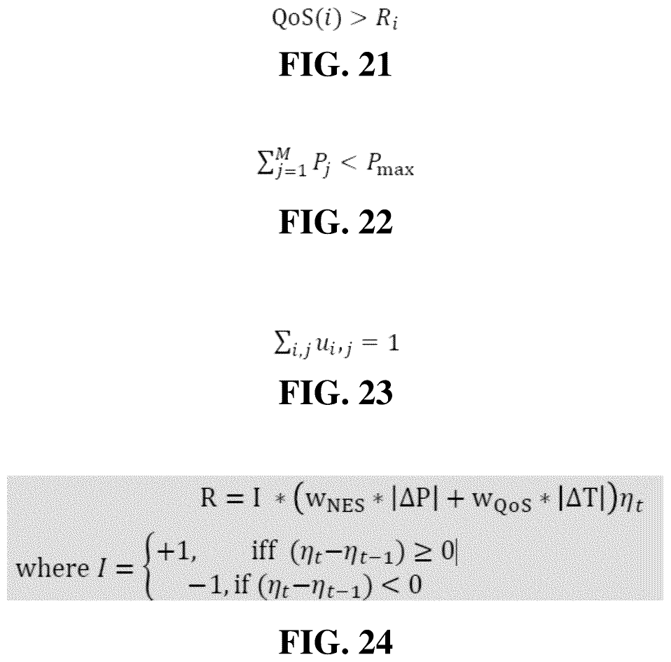

Eqn.(9) is subject to the following constraints, including, a tenth equation (Eqn.(10)) below (also illustrated in FIG. 21, in accordance with one or more embodiments) is a first constraint that represents the QoS of individual users (e.g., in the form of throughput being met).

$$QoS ( i ) > {R}_{i} \qquad Eqn . ( 10 )$$

An eleventh equation (Eqn.(11)) below (also illustrated in FIG. 22 in accordance with one or more embodiments) is a second constraint that represents the total energy consumed by all the shared RAN is subject to a maximum power constraint.

$${\sum }_{j = 1}^{M} {P}_{j} < {P}_{max} \qquad Eqn . ( 11 )$$

If a joint user association check can be conducted by the InP by communicating a user list with MNOs then a further check can be coordinated as per a twelfth equation (Eqn.(12)) below (also illustrated in FIG. 23 in accordance with one or more embodiments).

$${\sum }_{i , j} {u}_{i , j} = 1 \qquad Eqn . ( 12 )$$

such that a UE is only assigned to one shared RAN.

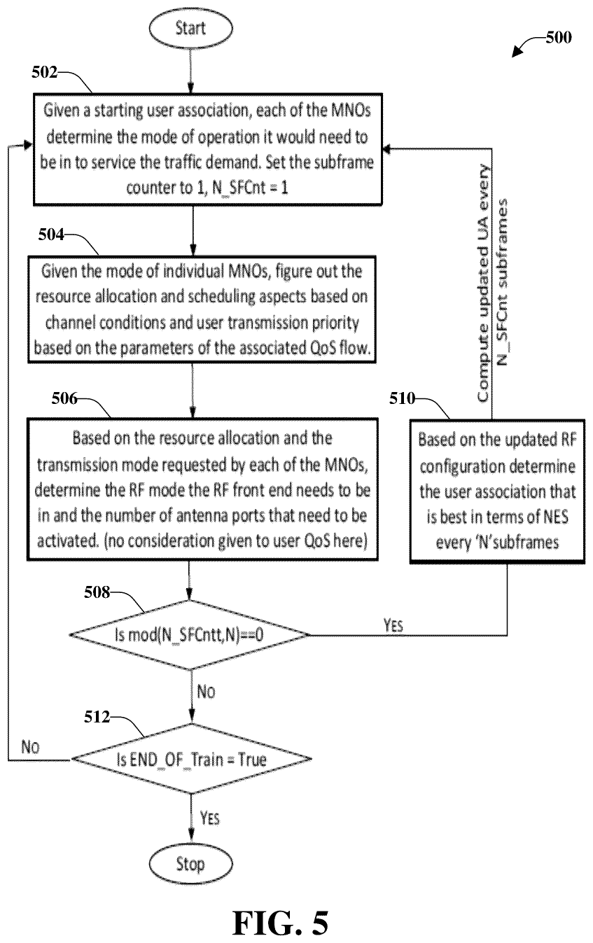

FIG. 5 illustrates an example, non-limiting, flow diagram of an example, non-limiting, computer-implemented method 500 that facilitates training of multilevel (hierarchical) DRLs for NES for shared-RAN in accordance with one or more embodiments described herein. The computer-implemented method 500 and/or other methods discussed herein can be implemented by network equipment comprising a processor. According to another example, the computer-implemented method can be implemented by a system comprising a processor and a memory.

Each of the tenant MNOs implement ES features such as advanced sleep modes (ASM), carrier & cell switch ON/OFF (CCSO) and are able to do this based on policy directives and furthermore apply user association in a way that benefits a global power consumption metric.

By employing a hierarchical DRL flow, task decomposition is leveraged such that the individual MNO RL engines cater to respective network traffic deploying ASMs opportunistically deployed for NES.

By using an InP level DRL further use is made of the principle of abstraction where at the infrastructure level, user association amongst MNO is performed in a way that aids in reduction of the cluster-level/global energy consumption reduction of the S-RAN.

Reward Shaping for both Intra-MNO Loop and Inter-MNO Loop is the same, the difference comes from the set of actions it is allowed to take. The reward is formulated as a thirteenth equation (Eqn.(13)) below (also illustrated in FIG. 24 in accordance with one or more embodiments).

$$R = I * ( {w}_{NES} * \vert P \vert + {w}_{QoS} * \vert Δ T \vert ) {η}_{t} \qquad Eqn . ( 13 )$$

$$where I = \{ \begin{matrix}+ 1 , iff ( {η}_{t} - {η}_{t - 1} ) \geq 0 \vert \\ - 1 , if ( {η}_{t} - {η}_{t - 1} ) < 0\end{matrix}$$

With continuing reference to FIG. 5, the computer-implemented method 500 starts, at 502, when, given a starting UE association, each of the MNOs determine the mode of operation that the respective MNO would need to be in to service the traffic demand. Further, the subframe counter is set to 1, N_SFCnt=1.

At 504, given the mode of the respective (e.g., individual) MNOs, a determination of the resource allocation and scheduling aspects is performed based on channel conditions and user transmission priority based on the parameters of the associated QoS flow.

Further, at 506, based on the resource allocation and the transmission mode requested by each of the MNOs, a determination of the RF mode and the RF front end needs to be in and the number of antenna ports that need to be activated. No consideration is given to UE QoS at this point in the computer-implemented method 500.

A determination is made, at 508, whether mod(N_{SFCnt}, N_{SF})==0. If equal to zero (“YES”), the computer-implemented method 500 continues, at 510 and, based on the updated RF configuration, a determination is made whether the UE association that is best in terms of NES every ‘N_{SF}’ subframes. The computer-implemented method 500 returns to 502 and an updated UA (user association) is computed every N_{SFCnt} subframes.

Alternatively, if the determination at 508 is that the value is not equal to zero (“NO”), at 512 a determination is made whether it is the end of the training (e.g., Is END_OF_Train=True). If not true (“NO”), the computer-implemented method 500 returns to 502. Alternatively, if the determination at 512 is that it is the end of the training (“YES”), the computer-implemented method 500 ends.

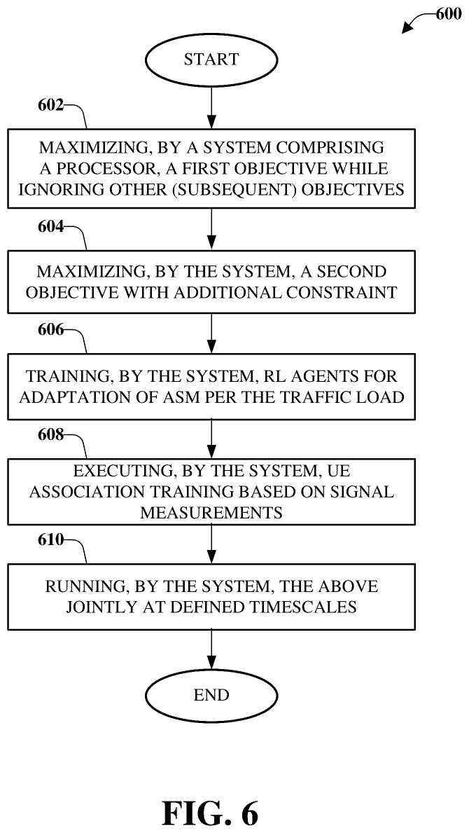

FIG. 6 illustrates an example, non-limiting, flow diagram of an example, non-limiting, computer-implemented method 600 that facilitates a training schedule for DRL based NES in Shared-RAN in accordance with one or more embodiments described herein. The computer-implemented method 600 and/or other methods discussed herein can be implemented by network equipment comprising a processor. According to another example, the computer-implemented method can be implemented by a system comprising a processor and a memory.

In some implementations, hierarchical RL is applied when one action or its impact can be categorized to be more important than another. For example, hierarchical RL can be applied for H1>H 2>H3, where H1, H2 and H3 are individual, but related optimal tasks, then the RL loops can be optimized in that order while the task of relatively higher importance has its training completed.

The optimization is conducted recursively by the computer-implemented method 600, which starts, at 602, by maximizing a first objective (e.g., H1) and ignoring other (subsequent) objectives (e.g., H2, H3, and so on). At 604, a second objective (e.g., H2), is maximized with additional constraint that the value of H1 is nearly optimal based on the previous optimization (at 602).

The computer-implemented method 600 then proceeds per the following steps. Task1: At 606, the RL agents corresponding to the individual agents are trained for adaptation of the ASMs per the traffic load on a 24-hr diurnal variation pattern considering the total load (without consideration for UE association). Task2: At 608, the InP then runs (e.g., executes) the user association training based on signal measurements such as RSRP or SINR (as the case may be) to achieve appropriate UA using diurnal and weekly position and channel-based data. Task3: At 610, in the final phase of training the above is jointly run whereby the UA iterations occur at a lot longer timescale than ASMs, for example, and then the resource allocation for optimal NES is achieved for the given UA per the InP.

In this case, the previous tasks are not of greater importance, but of different timescales and have different action sets. Finally, the third step (Task3) is a hybrid, where resource allocation is done with training with respect to Task1 and Task2 being completed.

As discussed herein, provided are embodiments related to achieving network energy savings in shared-RAN architecture where the power-consuming RAN hardware is owned by an InP and shared by network operators to provide coverage to an entire region but without having to own and deploy costly network radio equipment.

As a first example, each MNO is able to use energy-efficient scheduling per its own network policy and the network policy can be optimized using intra-MNO deep reinforcement learning loops. As a second example, the InP is able to employ a data-driven deep reinforcement learning based optimization where the objective is to reduce a global energy metric. The interoperability of the first example and second example are facilitated and ensured in a hierarchical manner such that the employing a data-driven deep reinforcement learning based optimization where the objective is to reduce a global energy metric executes at a longer timescale than the intra-MNO deep reinforcement learning loops. Further, in some embodiments, the training of individual DRL loops is done by achieving convergence for the DRL loop running at the lowest time scale first.

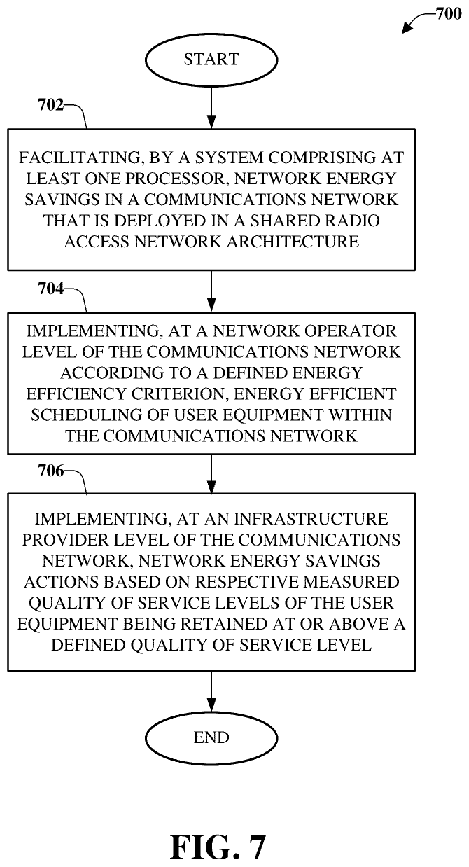

FIG. 7 illustrates an example, non-limiting, flow diagram of an example, non-limiting, computer-implemented method 700 that facilitates multiple-tenant energy efficient radio access network sharing in advanced communication networks in accordance with one or more embodiments described herein. The computer-implemented method 700 and/or other methods discussed herein can be implemented by network equipment comprising a processor. According to another example, the computer-implemented method can be implemented by a system comprising a processor and a memory.

The computer-implemented method 700 begins, at 702, with facilitating network energy savings in a communications network that is deployed in a shared radio access network architecture. For example, the shared radio access network architecture comprises radio access network hardware controllable by provider equipment associated with an infrastructure provider. A group of network operators share the radio access network hardware. Further, respective operator equipment associated with the group of network operators facilitate wireless communications coverage to a communication region defined by the communications network. According to some implementations, network equipment comprised by the communications network is configured to operate according to at least a fifth generation radio network communication protocol.

Facilitating the network energy savings can include, at 704, implementing, at a network operator level of the communications network according to a defined energy efficiency criterion, energy efficient scheduling of user equipment within the communications network. Additionally, facilitating the network energy savings can include, at 706, implementing, at an infrastructure provider level of the communications network, network energy savings actions based on respective measured quality of service levels of the user equipment being retained at or above a defined quality of service level.

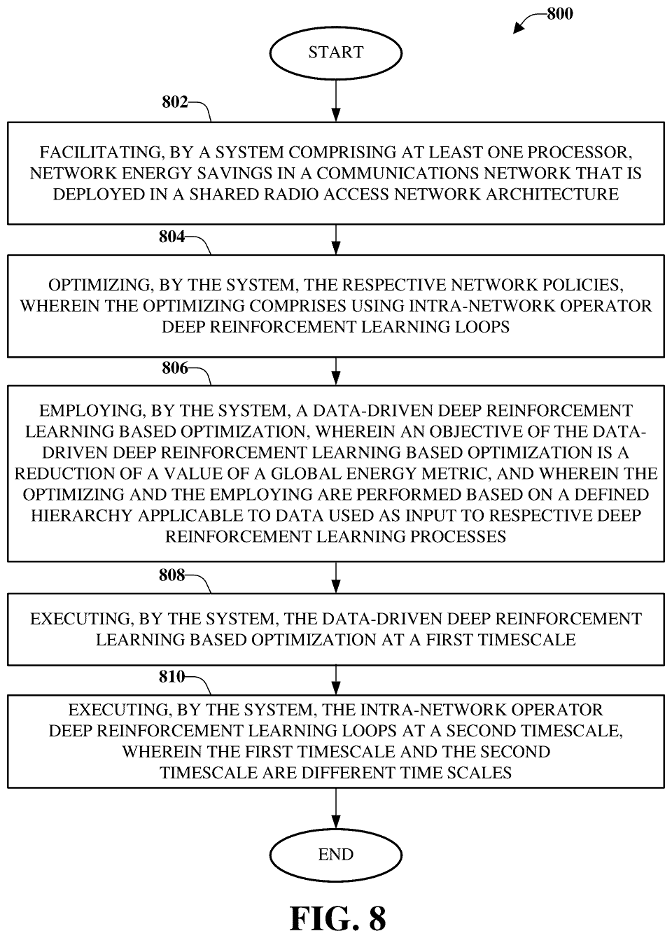

FIG. 8 illustrates an example, non-limiting, flow diagram of an example, non-limiting, computer-implemented method 800 that utilizes optimization loops to facilitate multiple-tenant energy efficient radio access network sharing in accordance with one or more embodiments described herein. The computer-implemented method 800 and/or other methods discussed herein can be implemented by network equipment comprising a processor. According to another example, the computer-implemented method can be implemented by a system comprising a processor and a memory.

The computer-implemented method 800 begins, at 802, with facilitating network energy savings in a communications network that is deployed in a shared radio access network architecture, as discussed with respect to the computer-implemented method 700 of FIG. 7. Further, the shared radio access network architecture comprises radio access network hardware controllable by provider equipment associated with an infrastructure provider. A group of network operators share the radio access network hardware. Further, respective operator equipment associated with the group of network operators facilitate wireless communications coverage to a communication region defined by the communications network. According to some implementations, network equipment comprised by the communications network is configured to operate according to at least a fifth generation radio network communication protocol.

Respective network operators of the group of network operators can be associated with respective network policies. According to an implementation, implementing the energy efficient scheduling can include implementing respective energy efficient scheduling associated with the respective network operators based on the respective network policies. For example, the computer-implemented method 800 can include, at 804, optimizing, by the system, the respective network policies, wherein the optimizing comprises using intra-network operator deep reinforcement learning loops.

Further, the computer-implemented method 800 can include, at 806, employing, by the system, a data-driven deep reinforcement learning based optimization. An objective of the data-driven deep reinforcement learning based optimization is a reduction of a value of a global energy metric. Further, the optimizing, at 804, and the employing, at 806, can be performed based on a defined hierarchy applicable to data used as input to respective deep reinforcement learning processes.

According to some implementations, the computer-implemented method 800 can include, at 808, executing, by the system, the data-driven deep reinforcement learning based optimization at a first timescale. At 810, the computer-implemented method 800 can include executing, by the system, the intra-network operator deep reinforcement learning loops at a second timescale. The first timescale and the second timescale are different time scales. For example, the first timescale comprises a first length that is longer than the length of the second timescale. In a specific example, the first timescale comprises a first length that is at least three times longer than a second length of the second timescale.

In accordance with some implementations, for the using of the intra-network operator deep reinforcement learning loops, at 804, can include training, by the system, respective deep reinforcement learning loops based on achieving convergence for a first deep reinforcement learning loop running at a lowest time scale, as compared to time scales for other deep reinforcement learning loops, other than the first deep reinforcement learning loop, prior to achieving convergence from the other deep reinforcement learning loops.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Example, non-limiting Non-Real Time RAN Intelligent Controller (Non-RT RIC) functions include service and policy management, RAN analytics, and model training for the near-Real Time RICs. In this regard, the Non-RT-RIC enables non-real-time (e.g., a first range of time, such as >1 second) control of RAN elements and their resources through applications, e.g., specialized applications called rApps. Example, non-limiting Near-Real Time RAN Intelligent Controller (Near-RT RIC) functions enable near-real-time optimization and control and data monitoring of O-CU and O-DU nodes in near-RT timescales (e.g., a second range of time representing less time than the first time range, such as between 10 milliseconds and 1 second). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RAN Intelligent Controller (RT RIC) can be designed to manage network functions at real time timescales (e.g., a third range of time representing less time than the first time range and the second time range, such as <10 milliseconds).

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

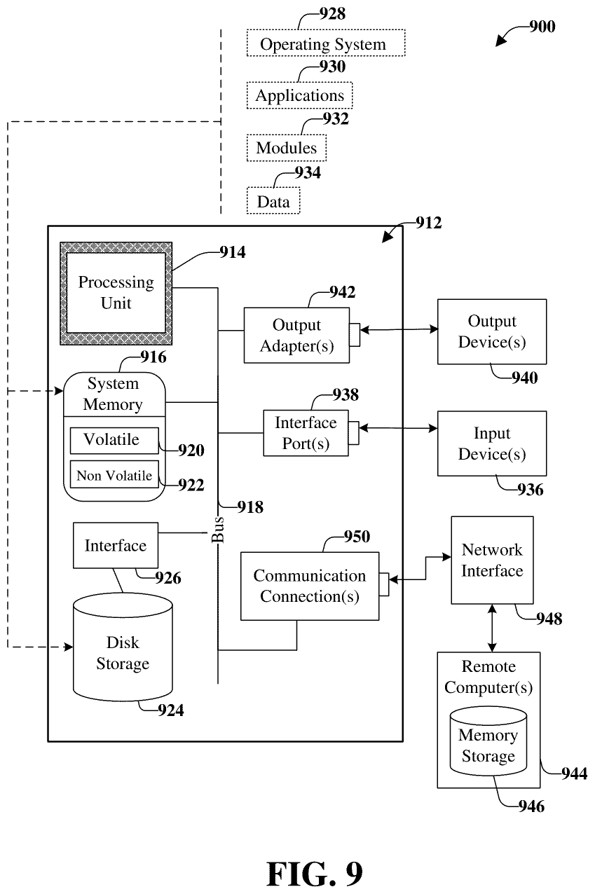

In order to provide a context for the various aspects of the disclosed subject matter, FIG. 9 as well as the following discussion are intended to provide a brief, general description of a suitable environment in which the various aspects of the disclosed subject matter can be implemented.

With reference to FIG. 9, an example environment 910 for implementing various aspects of the aforementioned subject matter comprises a computer 912. The computer 912 comprises a processing unit 914, a system memory 916, and a system bus 918. The system bus 918 couples system components including, but not limited to, the system memory 916 to the processing unit 914. The processing unit 914 can be any of various available processors. Multi-core microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 comprises volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can comprise read only memory (ROM), programmable ROM (PROM), electrically programmable ROM (EPROM), electrically erasable PROM (EEPROM), or flash memory. Volatile memory 920 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also comprises removable/non-removable, volatile/non-volatile computer storage media. FIG. 9 illustrates, for example a disk storage 924. Disk storage 924 comprises, but is not limited to, devices like a magnetic disk drive, floppy disk drive, tape drive, Jaz drive, Zip drive, LS-100 drive, flash memory card, or memory stick. In addition, disk storage 924 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used such as interface 926.

It is to be appreciated that FIG. 9 describes software that acts as an intermediary between users and the basic computer resources described in suitable operating environment 910. Such software comprises an operating system 928. Operating system 928, which can be stored on disk storage 924, acts to control and allocate resources of the computer 912. System applications 930 take advantage of the management of resources by operating system 928 through program modules 932 and program data 934 stored either in system memory 916 or on disk storage 924. It is to be appreciated that one or more embodiments of the subject disclosure can be implemented with various operating systems or combinations of operating systems.

A user enters commands or information into the computer 912 through input device(s) 936. Input devices 936 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 comprise, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapters 942 are provided to illustrate that there are some output devices 940 like monitors, speakers, and printers, among other output devices 940, which require special adapters. The output adapters 942 comprise, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically comprises many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the system bus 918. While communication connection 950 is shown for illustrative clarity inside computer 912, it can also be external to computer 912. The hardware/software necessary for connection to the network interface 948 comprises, for exemplary purposes only, internal, and external technologies such as, modems including regular telephone grade modems, cable modems and DSL modems, ISDN adapters, and Ethernet cards.

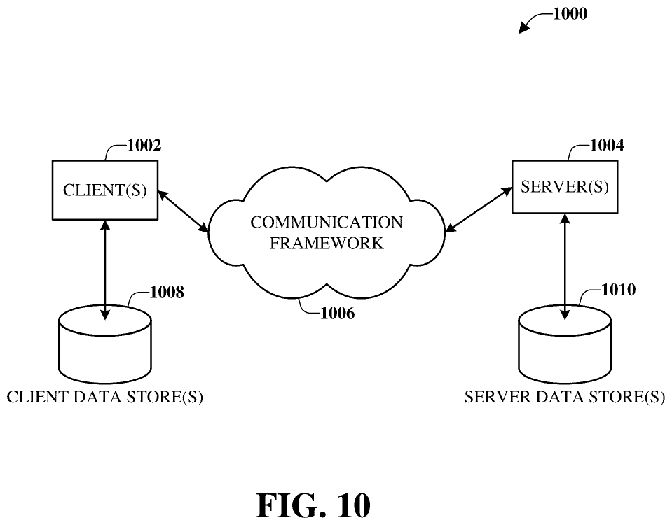

FIG. 10 is a schematic block diagram of a sample computing environment 1000 with which the disclosed subject matter can interact. The sample computing environment 1000 includes one or more client(s) 1002. The client(s) 1002 can be hardware and/or software (e.g., threads, processes, computing devices). The sample computing environment 1000 also includes one or more server(s) 1004. The server(s) 1004 can also be hardware and/or software (e.g., threads, processes, computing devices). The servers 1004 can house threads to perform transformations by employing one or more embodiments as described herein, for example. One possible communication between a client 1002 and servers 1004 can be in the form of a data packet adapted to be transmitted between two or more computer processes. The sample computing environment 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGS., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a system comprising at least one processor, network energy savings in a communications network that is deployed in a shared radio access network architecture, wherein the shared radio access network architecture comprises radio access network hardware controllable by provider equipment associated with an infrastructure provider, wherein a group of network operators share the radio access network hardware, wherein respective operator equipment associated with the group of network operators facilitate wireless communications coverage to a communication region defined by the communications network, and wherein the facilitating comprises:
implementing, at a network operator level of the communications network according to a defined energy efficiency criterion, energy efficient scheduling of user equipment within the communications network; and
implementing, at an infrastructure provider level of the communications network, network energy savings actions based on respective measured quality of service levels of the user equipment being retained at or above a defined quality of service level.

2. The method of claim 1, wherein respective network operators of the group of network operators are associated with respective network policies, and wherein the implementing the energy efficient scheduling comprises:
implementing respective energy efficient scheduling associated with the respective network operators based on the respective network policies.

3. The method of claim 2, further comprising:
optimizing, by the system, the respective network policies, wherein the optimizing comprises using intra-network operator deep reinforcement learning loops.

4. The method of claim 1, further comprising:
employing, by the system, a data-driven deep reinforcement learning based optimization, wherein an objective of the data-driven deep reinforcement learning based optimization is a reduction of a value of a global energy metric.

5. The method of claim 4, wherein the employing of the data-driven deep reinforcement learning based optimization is performed at the infrastructure provider level of the communications network.

6. The method of claim 1, wherein respective network operators of the group of network operators are associated with respective network policies, and wherein the method further comprises:
optimizing, by the system, the respective network policies, wherein the optimizing comprises using intra-network operator deep reinforcement learning loops; and
employing, by the system, a data-driven deep reinforcement learning based optimization, wherein an objective of the data-driven deep reinforcement learning based optimization is a reduction of a value of a global energy metric, and wherein the optimizing and the employing are performed based on a defined hierarchy applicable to data used as input to respective deep reinforcement learning processes.

7. The method of claim 6, further comprising:
executing, by the system, the data-driven deep reinforcement learning based optimization at a first timescale; and
executing, by the system, the intra-network operator deep reinforcement learning loops at a second timescale, wherein the first timescale and the second timescale are different time scales.

8. The method of claim 7, wherein the first timescale comprises a first length that is at least three times longer than a second length of the second timescale.

9. The method of claim 6, further comprising:
for the using of the intra-network operator deep reinforcement learning loops, training, by the system, respective deep reinforcement learning loops based on achieving convergence for a first deep reinforcement learning loop running at a lowest time scale, as compared to time scales for other deep reinforcement learning loops, other than the first deep reinforcement learning loop, prior to achieving convergence from the other deep reinforcement learning loops.

10. The method of claim 1, wherein network equipment comprised by the communications network is configured to operate according to at least a fifth generation radio network communication protocol.

11. A system, comprising:
at least one processor; and
at least one memory that stores executable instructions that, when executed by the at least one processor, facilitate performance of operations, comprising:
implementing, at an operator level of a cellular network deployed as a shared radio access network architecture, energy efficient scheduling of user equipment within the cellular network in accordance with a defined energy efficiency metric; and
implementing, at an infrastructure provider level of the cellular network, network energy savings actions in accordance with a defined energy savings metric based on respective measured quality of service levels of the user equipment being retained at or above a defined quality of service level.

12. The system of claim 11, wherein the shared radio access network architecture comprises radio access network hardware controlled by an infrastructure provider at the infrastructure provider level, wherein a group of network operators share the radio access network hardware at the operator level of the cellular network, and wherein the group of network operators facilitate wireless communications coverage to a communication region defined by the cellular network.

13. The system of claim 11, wherein respective network operators of the group of network operators are associated with respective network policies, and wherein the implementing of the energy efficient scheduling comprises:
implementing respective energy efficient scheduling associated with the respective network operators based on the respective network policies.

14. The system of claim 13, wherein the operations further comprise:
modifying the respective network policies using intra-network operator deep reinforcement learning loops based on additional training information having become available as input for the intra-network operator deep reinforcement learning loops.

15. The system of claim 11, wherein the operations further comprise:
employing a data-driven deep reinforcement learning based optimization, wherein an objective of the data-driven deep reinforcement learning based optimization is a modification of a value of a global energy metric to achieve a reduction in global energy usage.

16. The system of claim 11, wherein the operations further comprise:
optimizing the respective network policies, wherein the optimizing comprises using intra-network operator deep reinforcement learning loops; and
employing a data-driven deep reinforcement learning based optimization, wherein an objective of the data-driven deep reinforcement learning based optimization is a reduction of a value of a global energy metric to achieve a reduction in global energy usage.

17. The system of claim 16, wherein the operations further comprise:
executing the data-driven deep reinforcement learning based optimization at a first time interval; and
executing the intra-network operator deep reinforcement learning loops at a second time interval, wherein the first time interval and the second time interval are different time intervals, and wherein the first time interval comprises a first length that is longer than a second length of the second time interval.

18. A non-transitory machine-readable medium, comprising executable instructions that, when executed by at least one processor of network equipment, facilitate performance of operations, wherein the operations comprise:
configuring operations of network equipment of a communications network for energy efficiency according to a defined energy efficiency criterion, wherein the communications network is deployed in a shared radio access network architecture, and wherein the configuring comprises:
implementing, at a network operator level of the communications network applicable to network operator equipment of the communications network, energy efficient scheduling of user equipment within the communications network according to the defined energy efficiency criterion; and
implementing, at an infrastructure provider level of the communications network applicable to infrastructure provider equipment of the communications network, network energy savings actions based on respective measured quality of service levels of the user equipment being retained at or above a defined quality of service level.

19. The non-transitory machine-readable medium of claim 18, wherein respective network operator equipment of respective network operators of a group of network operators at the network operator level are associated with respective network policies, and wherein the operations further comprise:
modifying respective network policies using intra-network operator deep reinforcement learning loops; and
reducing a value of a global energy metric comprising employing data-driven deep reinforcement learning loops, wherein the modifying and the employing are performed independent from one another.

20. The non-transitory machine-readable medium of claim 19, wherein the operations further comprise:
training at least one of first loops of the intra-network operator deep reinforcement learning loops or second loops of the data-driven deep reinforcement learning loops based on having achieved a first convergence for a first deep reinforcement learning loop running at a lowest time scale, as compared to time scales for second deep reinforcement learning loops, other than the first deep reinforcement learning loop, prior to having achieved second convergence from the second deep reinforcement learning loops.
